(19) United States
(12) Patent Application Publication
(10) Pub. No.: US 2002/0167899 A1
(43) Pub. Date: Nov. 14, 2002

(54) System and method for the configuration, repair and protection of virtual ring networks

(76) Inventors: Richard A. Thompson, Hollis, NH (US); John Thomas Moy, Acton, MA (US); Vijayaragavan Pandian, Acton, MA (US)

Correspondence Address: LAHIVE & COCKFIELD, 28 STATE STREET, BOSTON, MA, 02109, US

(21) Appl. No.: 09/854,197

(22) Filed: May 11, 2001

(51) Int. Cl. H04L 12/26

(52) U.S. Cl. 370/222; 370/238

(57) ABSTRACT

A system and method for the configuration, protection and repair of virtual ring networks is revealed. The illustrative embodiment of the present invention provides a method of configuring an existing network topology, such as a mesh topology, into a virtual ring-based topology. The virtual rings disclosed are configurable through the use of software contained at the constituent nodes. The illustrative embodiment of the present invention enables a network carrier to make quality of service guarantees to customers equivalent to that expected from UPSR and BLSR based networks without having to employ expensive protection schemes. Node and trunk failures within the virtual ring are often repairable through path recalculation within the virtual ring thereby enabling shared protection schemes to be implemented for the virtual ring.

The invention relates generally to virtual ring networks and more particularly to the configuration, repair and protection of virtual ring networks.

### BACKGROUND OF THE INVENTION

Communication networks, such as long distance telephone networks, typically contain a plurality of nodes and trunks. The function of the node is to forward network traffic. The trunks represent physical media, such as telephone lines, ethernet cable or fiber-optic cable, that are used to connect the nodes in the network. Computers attached to networks communicate by sending messages through the network along a path of nodes and trunks. Data originates at a source node and travels to a destination node. The routes from one node in a network to another node in a network are referred to as paths and are determined by a routing algorithm based on predefined criteria, which may include time and cost of transit.

Conventional methods of configuring networks have involved the manual assignment of individual nodes to the network. This has not only resulted in large amounts of time being spent by network administrators in setting up the network, but has also made altering the network composition a difficult proposition. Adding and deleting nodes to a ring based network using conventional methods requires additional manual configuration of the other nodes in the network, which in turn requires the network administrator to spend additional time on the process.

Computer networks exist in a number of different topologies such as a ring topology and a mesh topology. A network with a mesh topology contains a plurality of interconnected nodes and trunks with a multitude of possible paths between nodes. Alternatively, a ring network is the simplest topology that is “two-connected,” that is, it provides two separate paths between any pair of nodes that do not have any nodes or links in common except for the source and destination nodes. Ring networks incorporate protection mechanisms that detect failures and re-route traffic away from failed links and nodes onto other routes rapidly. Three types of ring architectures have become popular: two-fiber Uni-directional Path Switched Rings (UPSR), four-fiber Bi-directional Line Switch Rings (BLSR/4), and two-fiber Bi-directional Line Switched rings (BLSR/2).

The UPSR ring topology requires the use of two fibers. Working traffic is transmitted in one direction on one fiber. The traffic is duplicated on the second fiber, designated as a “protection trunk”, and sent in the opposite direction. A receiving add/drop multiplexor (ADM) at the destination node compares the two copies of the message and selects the best one. This method is expensive in terms of fibers in that two fibers are used to send one fiber's worth of data. This type of protection scheme is known as path switching.

Some networks with a ring topology use a protection scheme known as line switching. Line switching, which is also known as one-to-one protection switching, is used in BLSR networks. In BLSR/4 networks, line switching is accomplished by duplicating bi-directional line connections between two point-to-point fiber multiplexors. Each point-to-point link is comprised of four fibers. Two of the four fibers are used to convey network traffic and are referred to as working trunks. One fiber of the working pair is used to transmit, and the other fiber in the working pair is used to receive. The bandwidth on the other two two fibers is reserved as protection in the event of failure of the working trunks, and the fibers are referred to as protection trunks. In order to avoid wasting bandwidth, the protection trunks may be used to carry “pre-emptible traffic” (“Pre-emptible traffic” is traffic that may be pre-empted and dropped from the transmission signal short of its destination in order to allow traffic with a higher priority to be transmitted. “Non pre-emptible traffic” will not be dropped from a transmission signal short of its destination as long as the network is functioning properly). If either of the two working lines fail, all traffic is switched to the protection pair and the pre-emptible traffic which was traveling on the protection trunks is pre-empted. The downside of this method of protection is that the one-to-one protection scheme requires four fibers for every point-to-point link in which only 2 fibers are being utilized at a time for non-premptible traffic. Similarly, the BLSR/2 architechture provides for two fiber bi-directional rings. Each point-to-point link consists of two fibers. Half of the first fiber is used to transmit data and the rest of the bandwidth is reserved for protection. The other fiber is used to receive data with half of the bandwidth being reserved for protection. This has the advantage over the BLSR/4 implementation in that only two fibers are required for each point-to-point link, but the disadvantage of only half of the bandwidth being utilized on each of the two fibers.

BLSR was developed for SONET/SDH ring environments and is effective in a single ring environment. However, the rings are not scalable and traffic providers are forced to install multiple parallel BLSR rings to meet demand. BLSR only provides the ability to share protection resources within a given ring, not among parallel rings. Additionally, BLSR requires the ring to be symmetric (have the same amount of working and protection bandwidth all the way around the ring). This symmetric requirement for the ring, along with the 1:1 protection requirement, often forces traffic providers to install excess bandwidth around the ring in response to having only one particularly busy segment. The UPSR and BLSR implementations enable carriers to make Quality of Service (QOS) guarantees to customers by promising minimal interruptions of service, but these guarantees come at the price of underutilized bandwidth. Additionally, the options for recovering from node and trunk failures within a ring topology are limited. Mesh networks provide more efficient means of recovering from trunk or node failures, but they represent a departure from the ring based topologies that traffic providers are familiar with using.

The conventional method of recovering from a node or a trunk failure in a network has been to calculate an alternate path around the failed trunk or node. Traditionally this has been accomplished by sending a message back to the source node from which the message originated and retransmitting the message on a new path to the destination node. Since carrier networks which provide network service to customers give certain quality of service (QOS) guarantees to their customers, the time delay in returning to the source node during a path failure, looking up an alternate path (if a protection circuit has not already been reserved), and retransmitting the packets, may be unacceptably large.

### SUMMARY OF THE INVENTION

The illustrative embodiment of the present invention provides a method to configure network topologies, such as mesh networks, into a virtual ring-based topology. The illustrative embodiment further provides a protection scheme utilizing shared protection bandwidth for the virtual ring. The shared protection bandwidth results in lower operating costs for the networks. The illustrative embodiment provides a method of reconfiguring the nodes into a virtual ring solely through the use of software. Traffic providers are able to experience a higher comfort level of dealing with a familiar ring topology while receiving the greater efficiencies available from the transparent mesh topology. Additionally, a method for recovery from path failure within the virtual ring, which recalculates the paths inside the virtual ring around the failure, is provided.

In one embodiment of the present invention, a computer network uses software containing routing algorithms to reconfigure the nodes in the network into a virtual ring. The virtual ring includes a plurality of working trunks and a plurality of protection trunks. The virtual ring further includes a circuit specific designated entry node, through which traffic passes into the virtual ring from the rest of the network, and a circuit specific designated exit node, through which network traffic passes from the virtual ring to destinations in the rest of the network outside the virtual ring.

In another embodiment of the present invention, a computer that includes a plurality of nodes and trunks, is re-configured through the use of software into a virtual ring topology. The virtual ring is formed by designating various nodes of the network as part of the virtual ring. The virtual ring includes a circuit specific designated entry node through which traffic passes from the rest of the network into the virtual ring, and a circuit specific designated exit node through which traffic passes from the virtual ring to destinations in the network outside the virtual ring. Failures of a working trunk in a path inside the virtual ring are repaired by calculating new routes for network traffic within the virtual ring, the new routes originating at the ring entry node and exiting the virtual ring at the circuit specific designated exit node.

In yet another embodiment, a computer network includes a plurality of nodes and trunks and is configured through the use of software into a virtual ring. Paths for network traffic are calculated for the virtual ring. The network traffic enters the virtual ring at a circuit specific designated entry node and proceeds through the ring, exiting the virtual ring at a circuit specific designated exit node. The virtual ring includes a plurality of working trunks and shared protection trunks. The shared protection trunks may be assigned to more than one calculated path through the virtual ring.

### BRIEF DESCRIPTION OF THE DRAWINGS

FIG. 1 depicts a network environment suitable for practicing an illustrative embodiment of the present invention;

FIG. 2 depicts one of the nodes from the virtual ring depicted in FIG. 1;

FIG. 3 depicts a virtual ring configured by an illustrative embodiment; and

FIG. 4 is a flow chart of the sequence of steps utilized by an illustrative embodiment of the present invention to transmit data from a source node to a destination node via a virtual ring.

### DETAILED DESCRIPTION OF THE INVENTION

The illustrative embodiment of the present invention provides a method of configuring an existing network topology, such as a mesh topology, into a virtual ring-based topology. The illustrative embodiment of the present invention enables a carrier to make quality of service (QOS) guarantees equivalent to that expected from UPSR and BLSR based networks. The virtual rings are configurable through the use of software contained at the constituent nodes. Node and trunk failures within the virtual ring are often repairable through path recalculation from the ring entry node, and as a result, the message does not have to return all the way to the source node to be retransmitted.

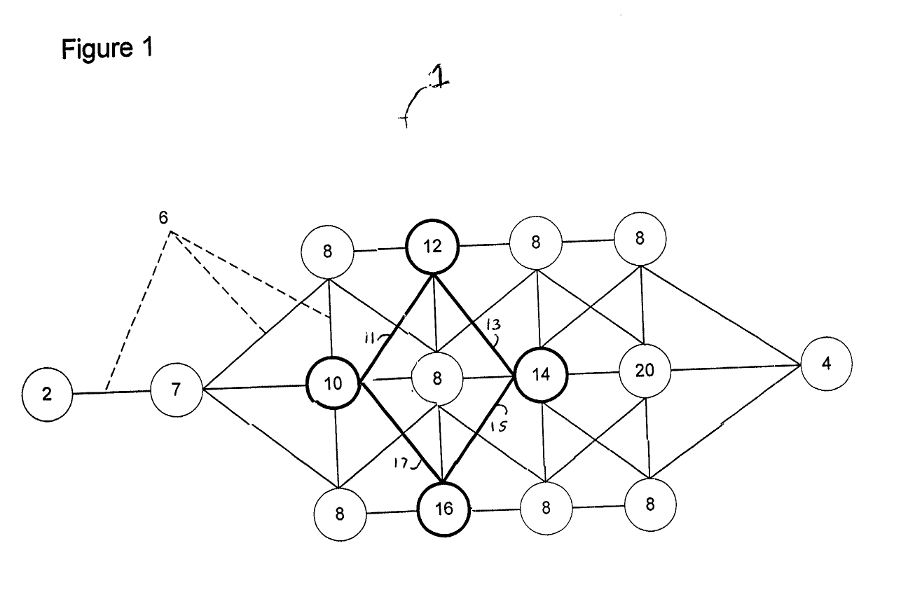

The illustrative embodiment of the present invention provides a method of overlaying a virtual UPSR or BLSR ring-like topology onto an existing mesh topology; thus creating a semblance of a network topology type with which carrier networks and their customers are familiar. FIG. 1 depicts the topology of a network 1 which includes a plurality of trunks and nodes suitable for practicing the illustrative embodiment of the present invention. The network 1 is arranged in a mesh topology and includes a source node 2 and a destination node 4. The network 1 also includes a plurality of trunks 6 and nodes 8. The trunks represent the physical media such as telephone lines, ethernet cable or fiber-optic cable used to connect the nodes in a network. Individual nodes 10, 12, 14 and 16 have been configured by software into a virtual ring, as have trunks 11, 13, 15 and 17.

A virtual ring is created by selecting a subset of the existing nodes and trunks in a network which are sufficient to form a ring topology when they are combined. The selected nodes are programmed to transmit data only via the selected nodes and trunks in the virtual ring. The procedures used to create such virtual ring will be described in more detail below.

A node 10 is designated as the entry node for the virtual ring and another node 14 is designated as the exit node for the virtual ring as each circuit is set up. Different circuits utilizing the same virtual ring may designate different ring exit and entry nodes. All data for the designated circuit entering the virtual ring from the network 1 does so by way of the ring entry node 10. All data for the designated circuit exiting from the virtual ring does so by way of the ring exit node 14. Data traveling from the source node 2 to the destination node 4 may travel a path from the source node to an intermediate node 7, and then travel from the intermediate node to the ring entry node 10. Data arriving at the ring entry node 10 is independently routed within the virtual ring to the ring exit node 14. Data may then travel to an intermediate node 20 and from the intermediate node to the destination node 4. For purposes of routing, the routing algorithm employed by the source node 2 treats the virtual ring as a single node. That is, the routing algorithm routes the path from the source node to the ring entry node and then from the ring exit node to the destination node. The path the data travels inside the virtual ring is independently determined by routing algorithms.

The nodes in the network represent pieces of hardware, such as switches, bridges or Add Drop Multiplexors (ADMs). The switches may be electrical switches, optical switches or a hybrid optical-electrical switch. Electrical switches require data to be converted from an optical signal into an electrical signal on entry into the switch and then converted back from the electrical signal into an optical signal for re-transmission on the optical network. These conversions of signal types slow down the transmission of data. An optical switch does not require any conversion of signal from optical to electronic and consequently is much faster. Unfortunately, all-optical switches currently cannot handle the required bandwidth of optical transmissions. A hybrid switch such as the SN-16000 from Sycamore Networks, Chelmsford, Mass., combines electrical and optical technology to process transmitted bandwidth at speeds faster than all-electrical switches.

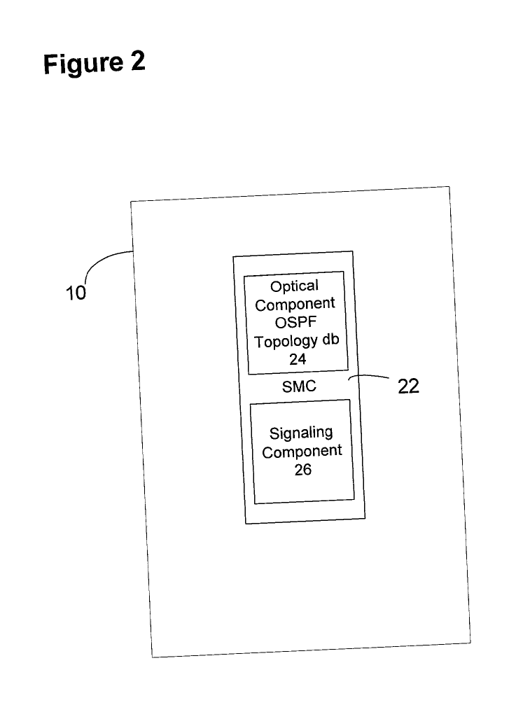

FIG. 2 depicts an SN-16000 hybrid switch as a node 10 of the network 1. The node 10 contains a switch management card (SMC)22 which contains software. The software on the SMC 22 includes an optical routing component 24 utilizing an Open Shortest Path First (OSPF) algorithm and a topology database. The topology database contains a listing of the connections between different nodes in the network and their current condition. The OSPF algorithm utilizes the information contained in the topology database during route calculation within the network. The software on the SMC 22 also includes a signaling component 26 which is utilized to set up the circuit, detect failures and initiate switchover in case of a failure.

In one embodiment of the present invention, a virtual ring is configured by assigning parameters such as LS-Ring-ID, LS-Ring-Type, LS-Ring-Role to the set of nodes and trunks that are part of the ring. LS-Ring ID is used to uniquely identify an LS-Ring in an optical domain. LS-Ring Type identifies the type of virtual ring being configured (ie: UPSR, BLSR). LS-Ring Role identifies trunks as working or protection trunks in BLSR rings. The parameters are stored in the topology database and identify the trunk or node as part of a virtual ring. The topology database is consulted by a routing algorithm module during path determination. In one aspect of the illustrative embodiment, the software module may contain both a routing component and a signaling component which combine to transmit data over the network. The routing component of the software is responsible for determining paths between the source and destination nodes and the signaling component is responsible for setting up the circuits. In the event of a node or trunk failure in the virtual ring, the signaling component and the optical routing component will work together for a recovery from failure. The optical routing component is responsible for calculating a replacement path utilizing protection trunks and making it available for the use of the signaling component. Upon repair of the failed node or trunk, the optical routing component is responsible for restoring the path to the original version. The illustrative embodiment of the present invention enables some path recalculation to be performed at the ring entry node of the virtual ring in a manner described more fully below.

The routing component of an optical network is responsible for calculating transmission paths. The calculation is performed using routing algorithms which take various cost factors such as time and expense into consideration. In one aspect of the illustrative embodiment, the routing component uses an Open Shortest Path First (OSPF) algorithm to determine paths, and the configured virtual ring is located entirely within an OSPF area. The OSPF algorithm involves the exchange of information between neighboring nodes regarding network conditions. The exchanged information is stored in a topology database. The information includes the length of hop (distance) between nodes and the associated cost factors of the hop.

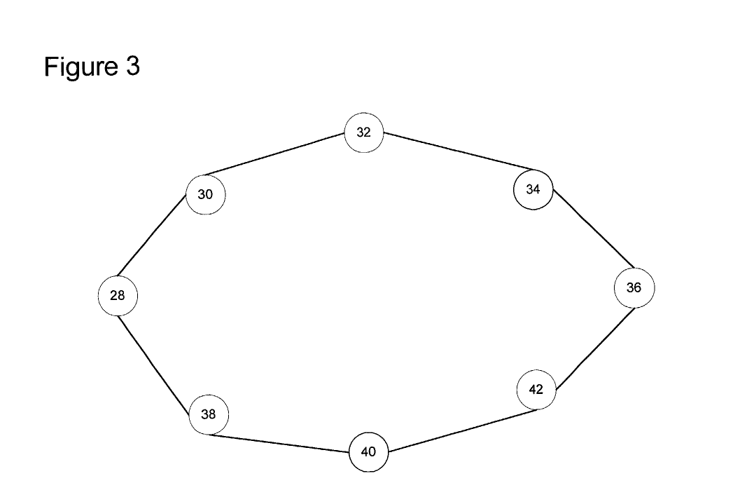

FIG. 3 depicts nodes in a mesh network which have been configured via software into a virtual ring. The virtual ring includes a node 28, designated as a ring entry node, a node designated as a ring exit node 36, and interim ring nodes 30, 32, 34, 38, 40, 42. Traffic arriving at the virtual ring arrives at the ring entry node 28. The illustrative embodiment of the present invention enables a virtual ring to mimic the performance of a UPSR or BLSR ring. In the event the virtual ring depicted in FIG. 3 is set up to mimic a UPSR ring, a working path from ring entry node 28 to ring exit node 36 must be designated, such as a clockwise path through the intermediate nodes 30, 32, 34. UPSR rings require that a protection path must be designated and the circuit reserved, such as a counterclockwise path running in the opposite direction in the virtual ring, from the ring entry node 28, through intermediate nodes 38, 40, 42 and concluding at the ring exit node 36. Pre-emptible traffic may be transported on the protection trunks while the working trunks are operating properly. If a node or trunk fails within the virtual UPSR ring, the circuits will be switched to the protection path which has been previously reserved and the pre-emptible traffic will be discarded.

In the case where the virtual ring depicted in FIG. 3 is set up to mimic the performance of a BLSR ring, there are a plurality of fibers between nodes 28, 30 to carry traffic. In virtual rings configured as BLSR/2 rings, there are two fibers between nodes 28, 30, whereas in BLSR/4 rings, there are four optical fibers between nodes 28, 30. Unlike conventional methods of configuring BLSR rings, however, the virtual rings do not require one-to-one protection bandwidth in order to guarantee the quality of service of a BLSR ring. Rather, the remaining optical fibers not being used as working trunks, are utilized as shared protection bandwidth. In order to ensure QOS, there must be at least as many protection trunks as the maximum number of working trunks between any two adjacent nodes in the virtual ring. In a conventional BLSR ring, the protection trunks forming a circuit from the ring entry node to the ring exit node are reserved at the same time the working trunks from the ring entry node to the ring exit node are reserved. However, in the virtual ring configured by the illustrative embodiment, the BLSR protection circuit is not reserved in advance. The paths designated as shared protection resources may carry pre-emptible traffic during normal operation.

In the virtual BLSR protection scheme utilized by the illustrative embodiment, a node or trunk failure causes a message to be sent back to the ring entry node. Well-known methods such as alarm indicating signals (AIS) are used to notify the ring entry node 28 of a trunk or node failure in the virtual ring. Upon receiving a failure message, the ring entry node 28 switches to one of the available optical fibers, and retransmits the message to the ring exit node. While the path recalculation at the ring entry node 28 entails some administrative cost, it is less than the administrative cost associated with maintaining a separate backup protection circuit for every working circuit. The quality of service guarantee of a BLSR ring is met because the failure message only goes back to the ring entry node before a path is recalculated rather than returning all the way to the source node outside the virtual ring. The time lost by not having a protection circuit reserved, is regained by not having to return all the way to the source node.

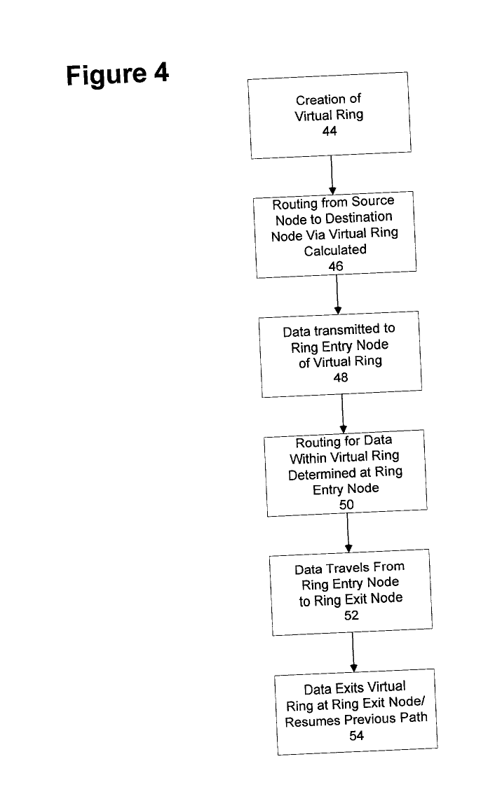

FIG. 4 represents a flowchart of the sequence of events involved in the transmission of data through the virtual ring of the present invention. A virtual ring is created within a network with a mesh topology by configuring a subset of selected nodes into a virtual ring 44. A path is calculated from a source node in the network to a destination node in the network that includes data travelling through a virtual ring 46. The data is then transmitted from the source node to the ring entry node of the virtual ring that was designated for the circuit 48. The ring entry node independently routes the data within the virtual ring from the ring entry node to the ring exit node 50. The data is transmitted from the ring entry node to the ring exit node that was designated for the circuit 52. Finally, the ring entry node transmits the data out of the virtual ring back onto the previously calculated path to the destination node 54.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the network topologies depicted in the figures may be altered without departing from the scope of the present invention and that the illustrations contained herein are singular examples of a multitude of possible depictions of the present invention.

We claim:

1. In a computer network, said network including a plurality of nodes and trunks, a method for configuring said network, said method comprising the steps of:
providing, at a selected node, software containing routing algorithms, said routing algorithms calculating routing paths for said network traffic, said network traffic originating at a source node and travelling to a destination node;
configuring a plurality of said nodes in said network through the use of said software so as to form a virtual ring composed of said nodes and trunks, said virtual ring containing a plurality of working trunks and a plurality of protection trunks, said virtual ring containing a designated entry node for each circuit designating the node through which network traffic passes from the nodes in the rest of the network which are not part of said virtual ring into said virtual ring, and said virtual ring further containing a designated exit node for each circuit, said exit node designating the node through which traffic passes from said virtual ring to other nodes in the rest of the network which are not part of the virtual ring.

2. The method of claim 1 wherein the number of protection trunks between any two adjacent nodes in a selected virtual ring equals the maximum number of working trunks between any other adjacent nodes in said selected virtual ring.

3. The method of claim 1 wherein traffic is routed through said virtual ring such that the virtual ring is treated as a single node during the calculation of said routing paths.

4. The method of claim 1 wherein said routing paths include a plurality of trunks in said virtual ring.

5. The method of claim 1 wherein said virtual ring is overlaid on a network possessing a mesh topology.

6. The method of claim 1 wherein said virtual ring is contained within a single Open Shortest Path First (OSPF) area.

7. In a computer network, said network including a plurality of nodes and trunks, a method for configuring said network, said method comprising the steps of:
providing, at a selected node, software containing routing algorithms, said routing algorithms calculating paths for said network traffic, said path for network traffic originating at a source node and travelling to a destination node;
configuring a plurality of said nodes in said network through the use of said software so as to form a virtual ring composed of said nodes and trunks, said virtual ring containing a plurality of working trunks and a plurality of protection trunks, said virtual ring containing a designated entry node for each circuit designating the node through which network traffic passes from the nodes in the rest of the network which are not part of said virtual ring into said virtual ring, and said virtual ring further containing a designated exit node for each circuit, said exit node designating the node through which traffic passes from said virtual ring to other nodes in the rest of the network which are not part of the virtual ring; and
repairing a failure in said path in said virtual ring, by calculating new routes for network traffic, said new route originating at said ring entry node and traveling through said ring exit node without traveling through the failed path.

8. The method of claim 7 wherein said virtual ring is contained within a single Open Shortest Path First (OSPF) area.

9. The method of claim 7 wherein the routing process for said network includes a signaling component and an optical routing component.

10. The method of claim 9 wherein the signaling component signals said optical routing component that the signaling component is performing a recovery from said failure.

11. The method of claim 10 wherein said optical routing component switches said path to include a protection trunk.

12. The method of claim 7 wherein an alarm indicating signal (AIS) is used to signal a path failure within said virtual ring.

13. The method of claim 7 wherein a path failure in said virtual ring is repaired by reprogramming cross-connects to use a secondary circuit path.

14. In a computer network, said network including a plurality of nodes and trunks, a method for configuring said network, said method comprising the steps of:
providing, at a selected node, software containing routing algorithms, said routing algorithms calculating paths for said network traffic, said path for network traffic originating at a source node and travelling to a destination node;
configuring a plurality of said nodes in said network through the use of said software so as to form a virtual ring composed of said nodes and trunks, said virtual ring containing a plurality of working trunks and a plurality of protection trunks, said virtual ring containing a designated entry node for each circuit designating the node through which network traffic passes from the nodes in the rest of the network which are not part of said virtual ring into said virtual ring, and said virtual ring further containing a designated exit node for each circuit, said exit node designating the node through which traffic passes from said virtual ring to other nodes in the rest of the network which are not part of the virtual ring; and
configuring said virtual ring so as to assign a protection trunk to more than one calculated path through said virtual ring.

15. The method of claim 14 wherein the routing process for said network includes a signaling component and an optical routing component.

16. The method of claim 15 wherein the signaling component signals said optical routing component that the signaling component is performing a recovery from said failure.

17. The method of claim 16 wherein said optical routing component switches said path to include a selected protection trunk.

18. The method of claim 17 wherein said selected protection trunk is the protection trunk for more than one calculated path through said virtual ring.

19. The method of claim 18 further comprising the steps of:
said entry node receiving notice of a failed working path through said virtual ring;
switching network traffic through said virtual ring to said selected protection trunk as part of a replacement path through said virtual ring;
repairing said failed working path through said virtual ring; and
switching network traffic through said virtual ring from said replacement path back to said working path.

20. The method of claim 14 wherein said virtual ring is contained within a single Open Shortest Path First (OSPF) area.
